(19) United States
(12) Patent Application Publication
(10) Pub. No.: US 2025/0020989 A1
(43) Pub. Date: Jan. 16, 2025

(54) ILLUMINATION OPTICAL SYSTEM AND PROJECTION-TYPE DISPLAY APPARATUS

(71) Applicant: SONY GROUP CORPORATION, Tokyo (JP)

(72) Inventor: Takashi SUDO, Tokyo (JP)

(21) Appl. No.: 18/712,839

(22) PCT Filed: Oct. 18, 2022
(86) PCT No.: PCT/JP2022/038797

§ 371 Date: May 23, 2024

(30) Foreign Application Priority Data
Dec. 3, 2021 (JP) 2021-197090

(51) Int. Cl. G03B 21/20

(52) U.S. Cl. CPC G03B 21/208

(57) ABSTRACT

An illumination optical system according to one embodiment of the present disclosure includes: a first fly-eye lens that divides exit light outputted from a light source into a plurality of light fluxes and expands the exit light to output expanded light, the first fly-eye lens including a plurality of first lens cells vertically and horizontally arranged in a matrix; and a second fly-eye lens disposed downstream of the first fly-eye lens, the second fly-eye lens including a plurality of second lens cells vertically and horizontally arranged in a matrix, the plurality of second lens cells having a one-to-one correspondence to the plurality of first lens cells included in the first fly-eye lens and having a lens pitch larger than a lens pitch of the plurality of first lens cells.

### TECHNICAL FIELD

The present disclosure relates to an illumination optical system including a pair of fly-eye lenses, and to a projection-type display apparatus including the illumination optical system.

### BACKGROUND ART

For example, PTL 1 discloses a liquid crystal projector that uses a first fly-eye lens and a second fly-eye lens to improve an illumination efficiency. The first fly-eye lens is disposed on a light source side, and has, in a lens surface of at least a portion of lens cells, a surface sag on one side in one direction out of a vertical direction and a horizontal direction. The second fly-eye lens is disposed on an illumination area side, and a lens cell thereof corresponding to the lens cell of the first fly-eye lens having the surface sag has an optical axis which is eccentric toward a side opposite to the one side, on, out of the vertical direction and the horizontal direction, a direction orthogonal to the one direction in which the surface sag of the lens cell of the first fly-eye lens is formed.

### CITATION LIST

### Patent Literature

PTL 1: Japanese Unexamined Patent Application Publication No. 2007-121447

### SUMMARY OF THE INVENTION

As described above, it is desired for a projection-type display apparatus to improve an illumination efficiency.

It is thus desirable to provide an illumination optical system and a projection-type display apparatus that each allow the illumination efficiency to be improved.

An illumination optical system according to one embodiment of the present disclosure includes: a first fly-eye lens that divides exit light outputted from a light source into a plurality of light fluxes and expands the exit light to output expanded light, the first fly-eye lens including a plurality of first lens cells vertically and horizontally arranged in a matrix; and a second fly-eye lens disposed downstream of the first fly-eye lens, the second fly-eye lens including a plurality of second lens cells vertically and horizontally arranged in a matrix, the plurality of second lens cells having a one-to-one correspondence to the plurality of first lens cells included in the first fly-eye lens and having a lens pitch larger than a lens pitch of the plurality of first lens cells.

A projection-type display apparatus according to one embodiment of the present invention includes: a light source: an illumination optical system: an image generation optical system that generates image light by modulating light from the illumination optical system on a basis of an input picture signal; and a projection optical system that projects the image light generated in the image generation optical system, and the projection-type display apparatus includes, as the illumination optical system, the above-described illumination optical system according to the one embodiment of the present disclosure.

The illumination optical system according to the one embodiment and the projection-type display apparatus according to the one embodiment of the present disclosure each use, as a pair of fly-eye lenses each including a plurality of lensless vertically and horizontally arranged in a matrix, the first fly-eye lens that divides the exit light outputted from the light source into a plurality of light fluxes and expands the exit light to output expanded light, and the second fly-eye lens disposed downstream of the first fly-eye lens, the second fly-eye lens including the plurality of second lens cells having a one-to-one correspondence to the plurality of first lens cells included in the first fly-eye lens and having a lens pitch larger than a lens pitch of the plurality of first lens cells. This allows an F-number of the pair of fly-eye lenses to be decreased.

### BRIEF DESCRIPTION OF DRAWING

FIG. 1 is a schematic diagram illustrating an example of a configuration of an illumination optical system according to an embodiment of the present disclosure and a projector including the illumination optical system.

FIG. 2 is a schematic diagram illustrating a configuration of a pair of fly-eye lenses illustrated in FIG. 1.

FIG. 3 is a diagram describing a first fly-eye lens illustrated in FIG. 1.

FIG. 4 is a diagram describing a second fly-eye lens illustrated in FIG. 1.

FIG. 5A is a perspective diagram illustrating an example of a specific structure of the first fly-eye lens illustrated in FIG. 1.

FIG. 5B is a perspective diagram illustrating an example of a specific structure of the second fly-eye lens illustrated in FIG. 1.

FIG. 6 is a diagram illustrating a lens surface shape in a vertical direction of the second fly-eye lens illustrated in FIG. 5B.

FIG. 7 is a diagram illustrating a lens surface shape in a horizontal direction of the second fly-eye lens illustrated in FIG. 5B.

FIG. 8 is a diagram describing optical paths of light beams that have entered the pair of fly-eye lenses illustrated in FIG. 1.

FIG. 9 is a schematic cross-sectional diagram describing a design structure of a general fly-eye lens.

FIG. 10 is a schematic cross-sectional diagram describing an actual structure of the general fly-eye lens.

FIG. 11 is a diagram illustrating calculation results of a step difference at a boundary portion of adjacent lens cells in a fly-eye lens whose lens surface has a spherical shape.

FIG. 12 is a diagram illustrating calculation results of a step difference at a boundary portion of adjacent lens cells in the fly-eye lens of the present disclosure.

FIG. 13 is a diagram illustrating positions of lens cells arranged in the vertical direction, which correspond to numbers on the horizontal axis illustrated in FIG. 11 and FIG. 12.

FIG. 14 is a schematic diagram illustrating an example of a configuration of a projector according to Modification Example 1 of the present disclosure.

FIG. 15 is a schematic diagram illustrating an example of a configuration of a projector according to Modification Example 2 of the present disclosure.

### MODES FOR CARRYING OUT THE INVENTION

In the following, some embodiments of the present disclosure will be described in detail with reference to the drawings. The following description is one specific example of the present disclosure, and the present disclosure is not limited to the following embodiments. In addition, the arrangement, dimensions, dimension ratios, and the like of components illustrated in each drawing in the present disclosure are also not limited to those embodiments. It is to be noted that the description will be given in the following order.
1. Embodiment (example of an illumination optical system in which, out of a pair of fly-eye lenses, a first fly-eye lens that expands incident light to output expanded light is disposed on a light source side)
2. Modification Example 1 (another example of a configuration of a projector)
3. Modification Example 2 (another example of the configuration of the projector)

### 1. Embodiment

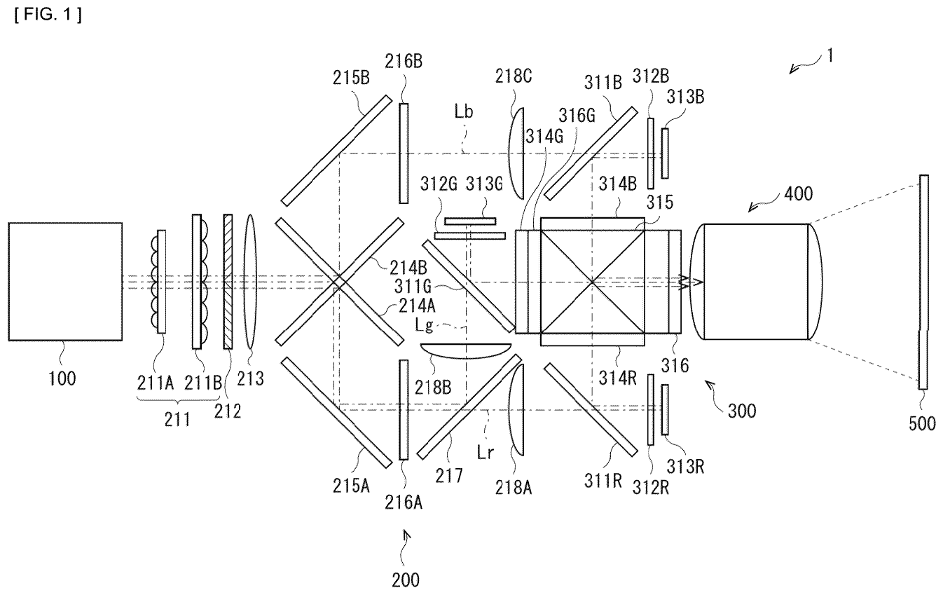

FIG. 1 is a diagram illustrating an example of a schematic configuration of a projection-type display apparatus (projector 1) according to one embodiment of the present disclosure. The projector 1 is, for example, a reflective 3LCD system projector that performs light modulation by using a reflective liquid crystal panel (LCD).

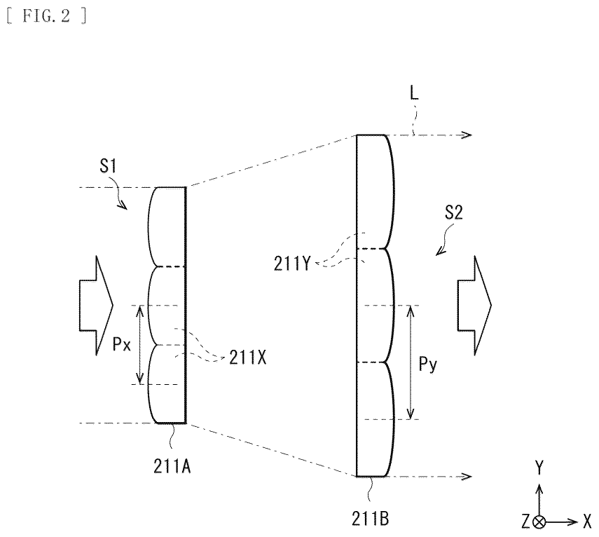

The projector 1 includes, for example, a light source 100, an illumination optical system 200, an image forming unit 300, and a projection optical system 400. The illumination optical system 200 includes a pair of fly-eye lenses 211. The illumination optical system 200 of this embodiment includes a first fly-eye lens 211A and a second fly-eye lens 211B as this pair of fly-eye lenses 211. The first fly-eye lens 211A includes a plurality of lens cells 211X vertically and horizontally arranged in a matrix, and, for example, as illustrated in FIG. 2, expands exit light L outputted from the light source 100 to output expanded light. The second fly-eye lens 211B is disposed downstream of the first fly-eye lens 211A, and includes a plurality of lens cells 211Y vertically and horizontally arranged in a matrix. The plurality of lens cells 211Y has a lens pitch larger than that of the plurality of lens cells 211X of the first fly-eye lens 211A.

### (Configurations of Fly-Eye Lenses)

The pair of fly-eye lenses 211 as a whole has a function of dividing the exit light L outputted from the light source 100 into a plurality of light fluxes to achieve a uniform luminance distribution. The pair of fly-eye lenses 211 includes the first fly-eye lens 211A and the second fly-eye lens 211B. The first fly-eye lens 211A is disposed on the light source 100 side, and the second fly-eye lens 211B is disposed downstream of the first fly-eye lens 211A.

The first fly-eye lens 211A includes the plurality of lens cells 211X vertically and horizontally arranged in a matrix, and corresponds to one specific example of “first fly-eye lens” of the present disclosure. In order to collect the exit light L outputted from each of the plurality of lens cells 211X to, for example, an illumination area (area having a predetermined margin with respect to an effective pixel region) of each of liquid crystal panels 313R, 313G, and 313B to be described later, a shape of a lens surface of each of the plurality of lens cells 211X is a substantially rectangular shape similar to this illumination area.

The second fly-eye lens 211B includes the plurality of lens cells 211Y vertically and horizontally arranged in a matrix, and corresponds to one specific example of “second fly-eye lens” of the present disclosure. The second fly-eye lens 211B is disposed at a substantial focal position of the plurality of lens cells 211X included in the first fly-eye lens 211A. The plurality of lens cells 211Y has a one-to-one correspondence to the plurality of lens cells 211X of the first fly-eye lens 211A. A shape of a lens surface of each of the plurality of lens cells 211Y is, similarly to the plurality of lens cells 211X, a substantially rectangular shape similar to the illumination area of each of the liquid crystal panels 313R, 313G, and 313B.

In this embodiment, the first fly-eye lens 211A and the second fly-eye lens 211B are each configured as follows.

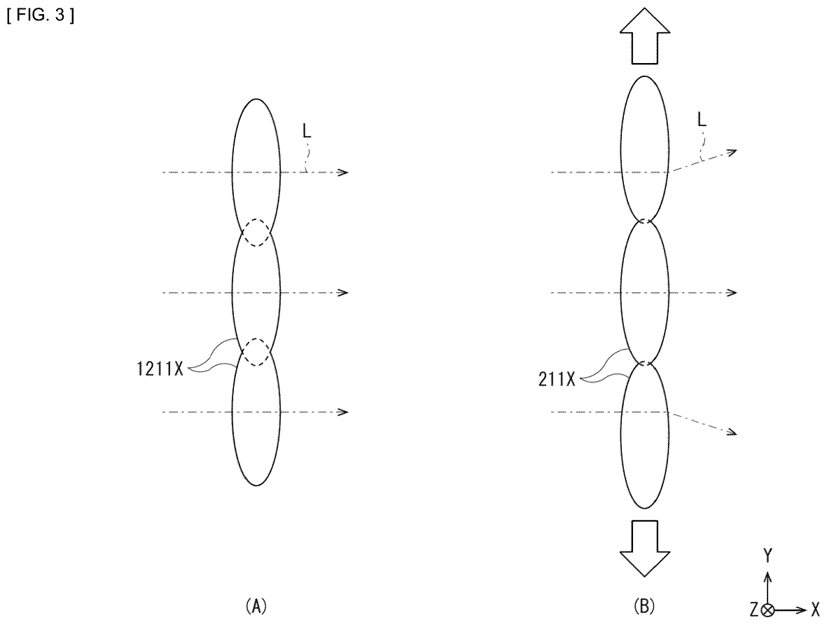

The first fly-eye lens 211A has, as illustrated in FIG. 2, a negative refractive index for diverging incident light (exit light L) as the whole fly eye, and is configured to expand the exit light L outputted from the light source 100 by a predetermined magnification to output the expanded light L. In each of the plurality of lens cells 211X of the first fly-eye lens 211A, for example, as compared with lens cells 1211X of a general fly-eye lens illustrated in part (A) of FIG. 3, an optical axis thereof is eccentric in a direction of the arrow illustrated in part (B) of FIG. 3, toward an outer side from a center portion of the first fly-eye lens 211A.

In detail, the optical axis of each of the plurality of lens cells 211X is eccentric by a predetermined amount in a vertical direction (for example, a Y-axis direction) and a horizontal direction (for example, a Z-axis direction) of a lens surface S1 of the first fly-eye lens 211A, toward the outer side from the center portion of the first fly-eye lens 211A.

The second fly-eye lens 211B has, as illustrated in FIG. 2, a positive refractive index for converging the incident light (exit light L) as the whole fly eye, and is configured to output each of the light fluxes output at a predetermined angle from each lens cell 211X of the first fly-eye lens 211A as parallel light. For example, the size of each of the plurality of lens cells 211Y of the second fly-eye lens 211B is larger than that of each of the plurality of lens cells 211X in accordance with expansion of the exit light L caused by the first fly-eye lens 211A. In other words, the plurality of lens cells 211Y included in the second fly-eye lens 211B is arranged at a pitch Py larger than a pitch Px of the plurality of lens cells 211X included in the first fly-eye lens 211A in both of the vertical direction and the horizontal direction (Py>Px).

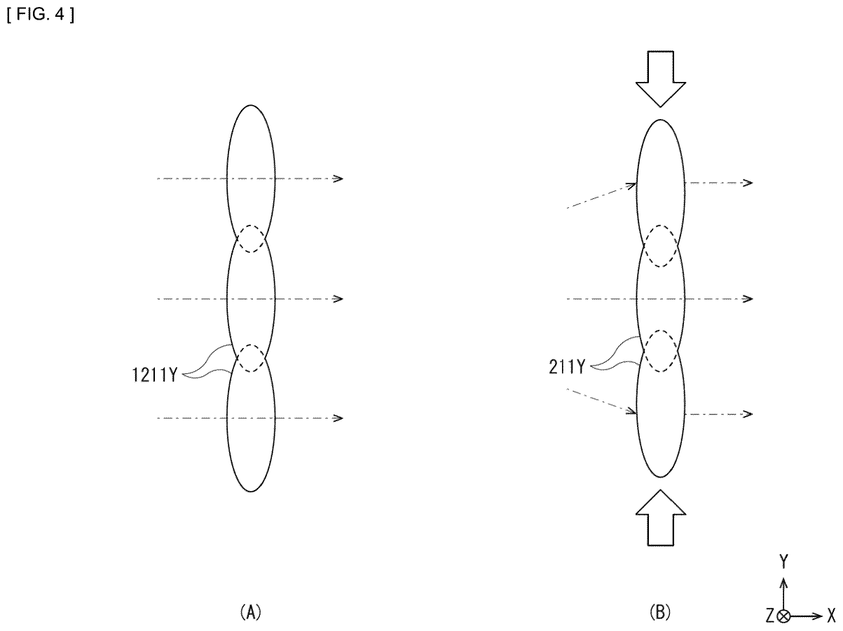

Moreover, in each of the plurality of lens cells 211Y of the second fly-eye lens 211B, for example, as compared with lens cells 1211Y of a general fly-eye lens illustrated in part (A) of FIG. 4, an optical axis thereof is eccentric in a direction of the arrow illustrated in part (B) of FIG. 4, toward an inner side from a center portion of the second fly-eye lens 211B.

In detail, the optical axis of each of the plurality of lens cells 211X is eccentric by a predetermined amount in the vertical direction (for example, the Y-axis direction) and the horizontal direction (for example, the Z-axis direction) of a lens surface S2 of the second fly-eye lens 211B, toward the inner side from the center portion of the second fly-eye lens 211B.

It is to be noted that the size of each of the lens cell 211X of the first fly-eye lens 211A and the lens cell 211Y of the second fly-eye lens 211B corresponds to an aspect ratio of the illumination area of each of the liquid crystal panels 313R, 313G, and 313B. Amounts of eccentricity in the vertical direction and the horizontal direction of each of the lens cells 211X and 211Y are different depending on F-numbers in the vertical direction and the horizontal direction of the illumination system. In this embodiment, the F-number of the illumination system is smaller in the horizontal direction than in the vertical direction, and hence the amount of eccentricity in the horizontal direction is larger than the amount of eccentricity in the vertical direction.

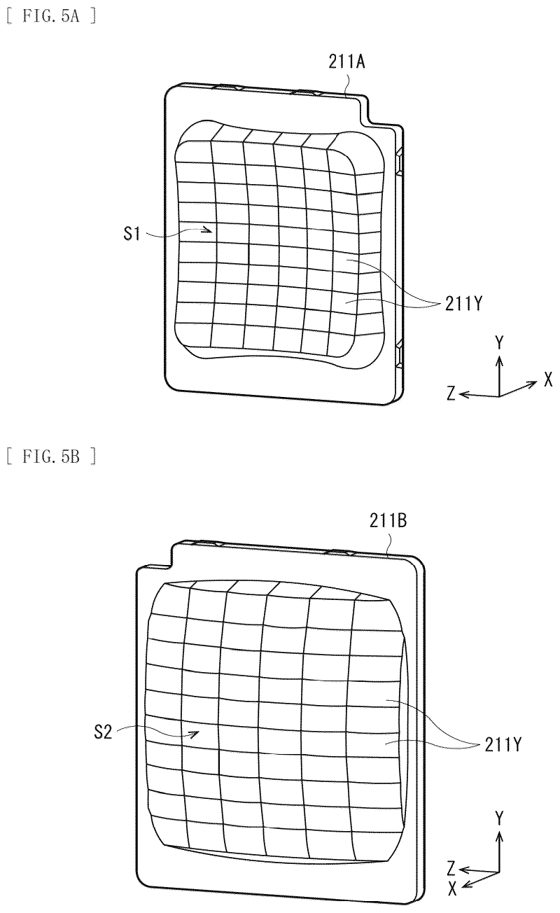

Further, each of the lens surface S1 of the first fly-eye lens 221A and the lens surface S2 of the second fly-eye lens 221B in this embodiment has a substantially paraboloidal surface shape. FIG. 5A is a perspective diagram illustrating an example of a specific structure of the first fly-eye lens 211A. FIG. 5B is a perspective diagram illustrating an example of a specific structure of the second fly-eye lens 211B. The lens surface S1 of the first fly-eye lens 221A is, for example, as illustrated in FIG. 5A, a concave substantially paraboloidal surface. The lens surface S2 of the second fly-eye lens 221B is, for example, as illustrated in FIG. 5B, a convex substantially paraboloidal surface.

The substantially paraboloidal lens surface S1 of the first fly-eye lens 221A is formed by shifting the plurality of lens cells 221X to the light source 100 side sequentially from the center portion of the first fly-eye lens 211A toward an outer side in a manner in which a step difference is prevented from being generated at a boundary position between a plurality of lens cells 221X adjacent to each other in the vertical direction and the horizontal direction. The substantially paraboloidal lens surface S2 of the second fly-eye lens 211B is formed by shifting the plurality of lens cells 221X to the light source 100 side sequentially from the center portion of the first fly-eye lens 211A toward an outer side in a manner in which a step difference is prevented from being generated at a boundary position between a plurality of lens cells 221X adjacent to each other in the vertical direction and the horizontal direction.

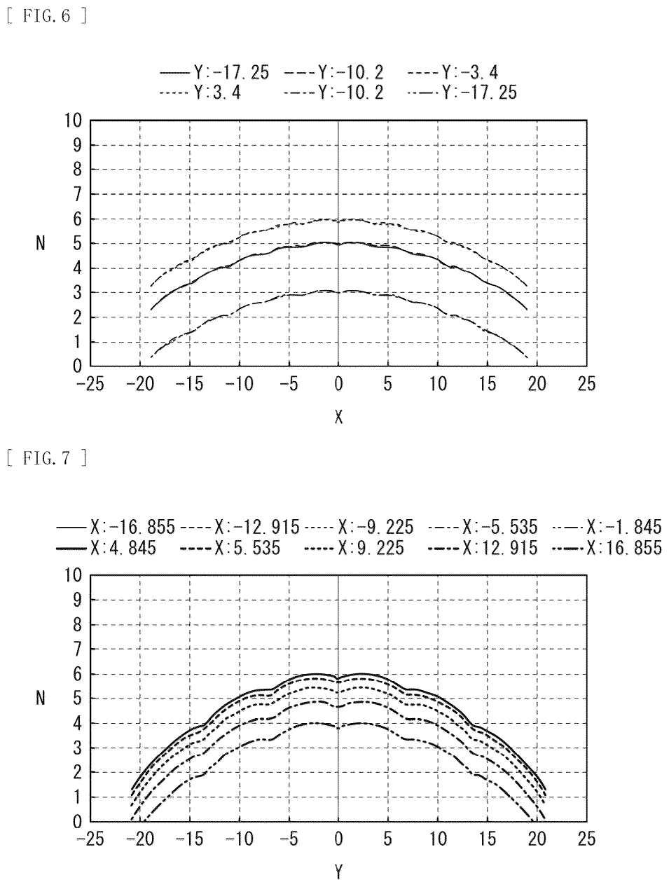

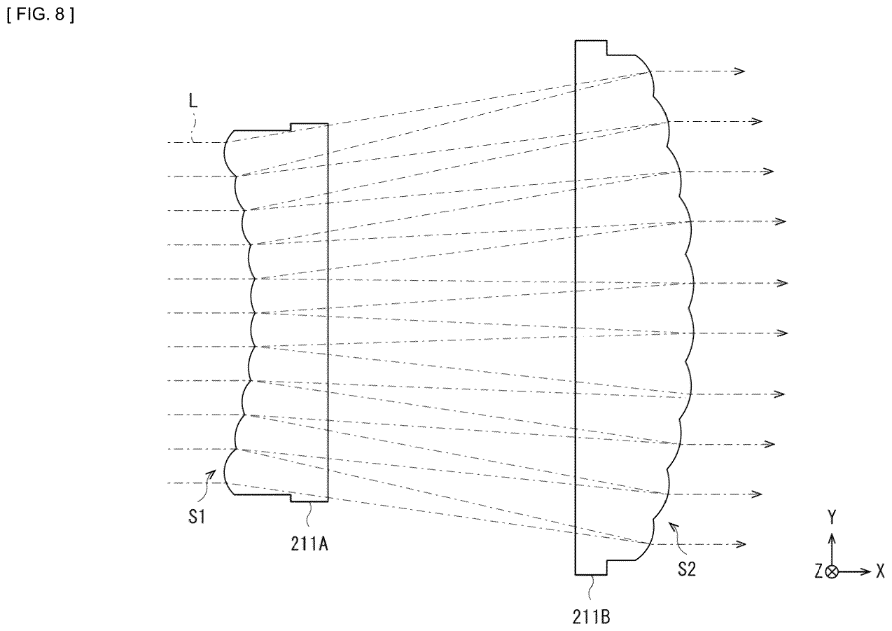

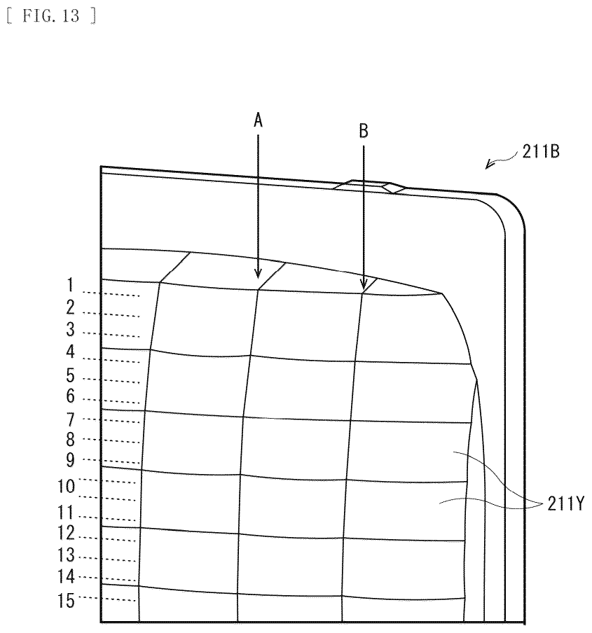

FIG. 6 illustrates, for each horizontal row, the shape of the lens surface S2 in the vertical direction (Y-axis direction) in a case of viewing the second fly-eye lens 211B from the horizontal direction (Z-axis direction). FIG. 7 illustrates, for each vertical column, the shape of the lens surface S2 in a case of viewing the second fly-eye lens 211B from the vertical direction (Y-axis direction). As illustrated, the lens surface S1 of the first fly-eye lens 221A and the lens surface S2 of the second fly-eye lens 221B are each formed into a paraboloidal surface shape. This allows a step difference to become 0 at any boundary position between a plurality of lens cells 221X or 221Y adjacent to each other in the vertical direction and the horizontal direction (see, for example, FIG. 12). As described above, as illustrated in FIG. 8, the exit light L outputted from the light source 100 passes through the lens cells 211X of the first fly-eye lens 211A to be divided into a plurality of light fluxes, which are each output at a predetermined angle to be imaged on a corresponding lens cell 211Y of the second fly-eye lens 211B. A plurality of light source images is formed on an exit surface of the second fly-eye lens 211B, and a plurality of parallel light beams are output.

### (Configuration of Projector)

The projector 1 illustrated in FIG. 1 is, as described above, a reflective 3LCD system projector that performs light modulation by using a reflective LCD, and includes the above-described pair of fly-eye lenses 211.

The light source 100 emits, for example, white light Lw including red light Lr, green light Lg, and blue light Lb. The light source 100 includes, for example, a plurality of light emitting devices that emits light in a predetermined wavelength range. Examples of the plurality of light emitting devices include edge-emitting type semiconductor lasers (LDs). Further, the light source 100 includes, for example, a plurality of types of light emitting devices that emits light beams in wavelength ranges that are different from each other. The plurality of types of light emitting devices includes a red light emitting device that emits light in a wavelength range corresponding to red (red light Lr), a green light emitting device that emits light in a wavelength range corresponding to green (green light Lg), and a blue light emitting device that emits light in a wavelength range corresponding to blue (blue light Lb).

It is to be noted that the light source 100 is not limited to an edge emitting laser. As the plurality of light emitting devices, it is possible to use, in addition to edge emitting lasers, surface emitting lasers, lamps, light emitting diodes (LEDs), wavelength conversion devices, and other devices.

The illumination optical system 200 includes, for example, the above-described pair of fly-eye lenses 211, a polarization conversion device 212, and a condensing lens 213.

The polarization conversion device 212 has a function of aligning polarization states of incident light beams entering the polarization conversion device 212 via the pair of fly-eye lenses 211 and the like.

The pair of fly-eye lenses 211 as a whole has a function of adjusting the incident light applied to each of the liquid crystal panels 313R, 313G, and 313B from the light source 100 to have a uniform luminance distribution.

The light (white light Lw) outputted from the light source 100 to enter the pair of fly-eye lenses 211 passes through the lens cells 211X of the first fly-eye lens 211A to be divided into a plurality of light fluxes, which are each imaged on a corresponding lens cell 211Y of the second fly-eye lens 211B. The lens cells 211Y of the second fly-eye lens 211B each function as a secondary light source, and output a plurality of parallel light beams having a uniform luminance toward the polarization conversion device 212.

The illumination optical system 200 further includes dichroic mirrors 214A, 214B, and 217, reflecting mirrors 215A and 215B, polarizing plates 216A and 216B, and field lenses 218A, 218B, and 218C.

The dichroic mirrors 214A and 214B each have a property of selectively reflecting color light in a predetermined wavelength range and transmitting light in other wavelength ranges. For example, the dichroic mirror 214A selectively reflects the red light Lr and the green light Lb. The dichroic mirror 214B selectively reflects the blue light Lb.

The reflecting mirror 215A reflects the red light Lr and the green light Lg reflected by the dichroic mirror 214A, toward the polarizing plate 216A. The reflecting mirror 215B reflects the blue light Lb reflected by the dichroic mirror 214B, toward the polarizing plate 216B.

The polarizing plates 216A and 216B each include a polarizer having a polarization axis in a predetermined direction. For example, in a case where the polarization conversion device 212 performs P-polarization conversion, the polarizing plate 216A transmits P-polarized light of the red light Lr and the green light Lg, and reflects S-polarized light thereof. Symbol 216B transmits P-polarized light of the blue light Lb, and reflects S-polarized light thereof.

The dichroic mirror 217 selectively reflects the green light Lg among the red light Lr and the green light Lg outputted from the polarizing plate 216A, and the remaining red light Lr passes through the dichroic mirror 217. This allows the white light Lw outputted from the light source 100 to be separated into a plurality of color light beams that are different from each other (red light Lr, green light Lg, and blue light Lb).

The field lenses 218A, 218B, and 218C each have a function of condensing a corresponding one of the red light Lr, the green light Lg, and the blue light Lb and illuminating a corresponding one of the liquid crystal panels 313R, 313G, and 313B.

The image forming unit 300 includes reflective polarizing plates 311R, 311G, and 311B, compensating plates 312R, 312G, and 312B, the liquid crystal panels 313R, 313G, and 313B, polarizing plates 314R, 314G, and 314B, and a dichroic prism 315. A wavelength-selective phase-difference device 316 is disposed between the dichroic prism 315 and the projection optical system 400.

The reflective polarizing plates 311R, 311G, and 311B each transmit light having the same polarization axis as the polarization axes of the polarizing plates 216A and 216B (for example, P-polarized light), and each reflect light having the other polarization axis (S-polarized light). For example, the reflective polarizing plate 311R transmits the P-polarized red light Lr in a direction of the liquid crystal panel 313R. The reflective polarizing plate 311G transmits the P-polarized green light Lg in a direction of the liquid crystal panel 313G. The reflective polarizing plate 311B transmits the P-polarized blue light Lb in a direction of the liquid crystal panel 313B. Further, the reflective polarizing plate 311R reflects the S-polarized red light Lr outputted from the liquid crystal panel 313R, toward the dichroic prism 315. The reflective polarizing plate 311G reflects the S-polarized green light Lg outputted from the liquid crystal panel 313G, toward the dichroic prism 315. The reflective polarizing plate 311B reflects the S-polarized blue light Lb outputted from the liquid crystal panel 313B, toward the dichroic prism 315.

The compensating plates 312R, 312G, and 312B have functions of compensating for respective phase-difference components to be caused in the liquid crystal panels 313R, 313G, and 313B at the time of black display.

The liquid crystal panels 313R, 313G, and 313B are each electrically coupled to a signal source (for example, a PC) (not illustrated) that supplies an image signal including image information. The liquid crystal panels 313R, 313G, and 313B each modulate incident light for each pixel to generate a corresponding one of a red image, a green image, and a blue image on the basis of the supplied image signal of each color. The modulated light beams of the respective colors (formed images) enter the dichroic prism 315 via the compensating plates 312R, 312G, and 312B, the reflective polarizing plates 311R, 311G, and 311B, and the polarizing plates 314R, 314G, and 314B, and are thus combined.

The dichroic prism 315 combines the color light beams that have entered the dichroic prism 315 via the compensating plates 312R, 312G, and 312B, the reflective polarizing plates 311R, 311G, and 311B, and the polarizing plates 314R, 314G, and 314B, and outputs the combined color light beams toward the projection optical system 400. Specifically, the red light Lr enters the dichroic prism 315 via the compensating plate 312R, the reflective polarizing plate 311R, and the polarizing plate 314R, and is thus combined. The green light Lg enters the dichroic prism 315 via the compensating plate 312G, the reflective polarizing plate 311G, the polarizing plate 314G, and a λ/2 plate 316G, and is thus combined. The blue light Lb enters the dichroic prism 315 via the compensating plate 312B, the reflective polarizing plate 311B, and the polarizing plate 314B, and is thus combined.

The polarizing plates 314R, 314G, and 314B are each a polarizer that further cuts an unnecessary polarization component that has not been sufficiently cut by a corresponding one of the reflective polarizing plates 311A, 311B, and 311C at the time of black display.

The dichroic prism 315 includes three incident surfaces and one exit surface, and has a function of superimposing and combining the color light beams (red light Lr, green light Lg, and blue light Lb) that have entered the dichroic prism 315 from the respective incident surfaces to output the combined color light beams. The dichroic prism 315 combines the incident red light Lr, green light Lg, and blue light Lb to output the combined light toward the projection optical system 400.

The wavelength-selective phase-difference device 316 has a property of rotating the polarization direction only in a selective wavelength range (for example, a red range, a green range, or a blue range). The wavelength-selective phase-difference device 316 may be bonded to, for example, the exit surface of the dichroic prism 315. As another example, the wavelength-selective phase-difference device 316 may be mechanically coupled to the incident side of the projection optical system 400.

In the projector 1, the polarization component of each color light beam entering the dichroic prism 315 is, for example, the S-polarized component in the case of the red light Lr and the blue light Lb, and is the P-polarized component in the case of the green light Lg. The wavelength-selective phase-difference device 316 is configured to perform selective polarization conversion of light in a green range, for example. Out of the light beams outputted from the dichroic prism 315, a light beam in the green range is selectively converted into an S-polarized component. This allows image light having aligned polarization components to be output toward the projection optical system 400.

The projection optical system 400 includes, for example, a plurality of lenses, and expands the exit light outputted from the image forming unit 300 to project the expanded light onto a screen 500.

### Actions and Effects

In the illumination optical system 200 and the projector 1 according to this embodiment, as described above, as the pair of fly-eye lenses 211, the first fly-eye lens 211A and the second fly-eye lens 211B are provided. The first fly-eye lens 211A includes the plurality of lens cells 211X vertically and horizontally arranged in a matrix, and expands the exit light L outputted from the light source 100 to output the expanded light. The second fly-eye lens 211B is disposed downstream of the first fly-eye lens 211A, and includes the plurality of lens cells 211Y vertically and horizontally arranged in a matrix. The plurality of lens cells 211Y has a lens pitch larger than that of the plurality of lens cells 211X of the first fly-eye lens 211A. This allows the F-number of the pair of fly-eye lenses 211 to be decreased. Details are described below.

In recent years, there is a demand for a small-sized and high-luminance projector. For achievement of a small-sized and high-luminance projector, it is important to downsize not only the light source but also the illumination optical system. Meanwhile, in a case where the liquid crystal panel has a large inch size relative to the light source and the illumination optical system, there arises a disadvantage of reduction in geometric efficiency. For example, in a case where exit light outputted from a light source is proved by a general fly-eye lens, the F-number is increased, and the illumination efficiency is greatly reduced.

In contrast, in this embodiment, the first fly-eye lens 211A that expands the exit light L outputted from the light source 100 to output the expanded light is disposed on the light source side, and the second fly-eye lens 211B including the plurality of lens cells 211Y vertically and horizontally arranged in a matrix and having a lens pitch larger than that of the plurality of lens cells 211X of the first fly-eye lens 211A is disposed downstream of the first fly-eye lens 211A. This makes it possible to decrease the F-number of the pair of fly-eye lenses 211.

As described above, the illumination optical system 200 according to this embodiment and the projector 1 including this illumination optical system 200 each allow the illumination efficiency to be improved.

Further, in this embodiment, each of the lens surface S1 of the first fly-eye lens 221A and the lens surface S2 of the second fly-eye lens 221B has a substantially paraboloidal surface shape.

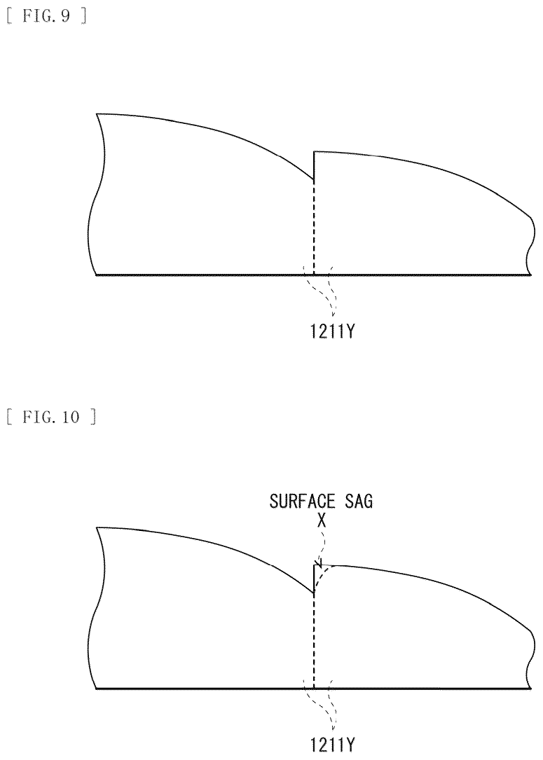

In general, in a fly-eye lens including a plurality of lens cells vertically and horizontally arranged in a matrix, in a case where the optical axis of each of the plurality of lens cells is made eccentric to form a lens surface into, for example, a spherical shape, as illustrated in FIG. 9, a step difference is caused in principle at a boundary portion between adjacent lens cells 1211Y.

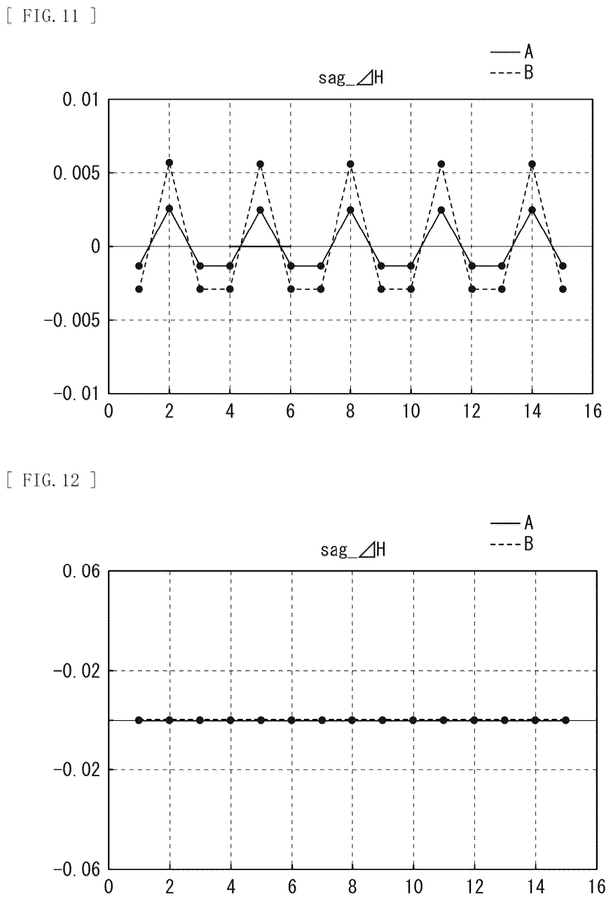

However, when the fly-eye lens having the shape illustrated in FIG. 9 is manufactured (for example, when this fly-eye lens is molded with a mold), for example, as illustrated in FIG. 10, such a phenomenon that a cross-sectional shape of a peripheral edge portion of the lens cell 1211Y becomes a curved surface shape that is different from an original lens shape (so-called “surface sag”) sometimes occurs more obviously on a specific side of the lens surface of the lens cell 1211Y than on a side opposite thereto.

For example, presence of a surface sag X on a specific side of the lens surface of the lens cell of the fly-eye lens disposed on the light source side causes light applied to the liquid crystal panel via this lens cell to be reduced in light amount on a specific side of the illumination area. This reduction in light amount is displayed as a dark shadow on the screen, which leads to reduction in image quality.

FIG. 11 illustrates calculation results of a step difference (sag_ΔH) at a boundary portion between adjacent lens cells in a fly-eye lens whose lens surface has a spherical shape. FIG. 12 illustrates calculation results of a step difference at a boundary portion between adjacent lens cells in, for example, the second fly-eye lens 211B. FIG. 13 illustrates a correspondence relationship between the number on the horizontal axis illustrated in FIG. 11 and FIG. 12 and the position of each of the lens cells arranged in the vertical direction, by using, for example, the second fly-eye lens 211B illustrated in FIG. 5B. It is to be noted that the calculation results of the step difference of FIG. 11 and FIG. 12 are each obtained at a boundary portion between lens cells having the same amount of eccentricity.

In the fly-eye lens whose lens surface has a spherical shape, the step difference (sag_ΔH) at the boundary portion between the adjacent lens cells changes depending on the position in each lens cell, and also varies depending on the position of the boundary portion in the lens surface. In contrast, in the second fly-eye lens 211B whose lens surface (for example, lens surface S2) has a paraboloidal surface shape, the step difference (sag_ΔH) at the boundary portion between the adjacent lens cells is 0 regardless of the position in each lens cell 211Y and the position of the boundary portion in the lens surface S2.

That is, formation of each of the lens surface S1 of the first fly-eye lens 221A and the lens surface S2 of the second fly-eye lens 221B into a substantially paraboloidal surface shape allows the illumination area to be increased as compared with the case of the general fly-eye lens. It is thus possible to further improve the illumination efficiency and also improve the image quality.

Next, Modification Examples 1 and 2 of the present disclosure are described. In the following, components similar to those in the above-described embodiment are denoted by the same reference symbols, and description thereof is omitted as appropriate.

### 2. Modification Example 1

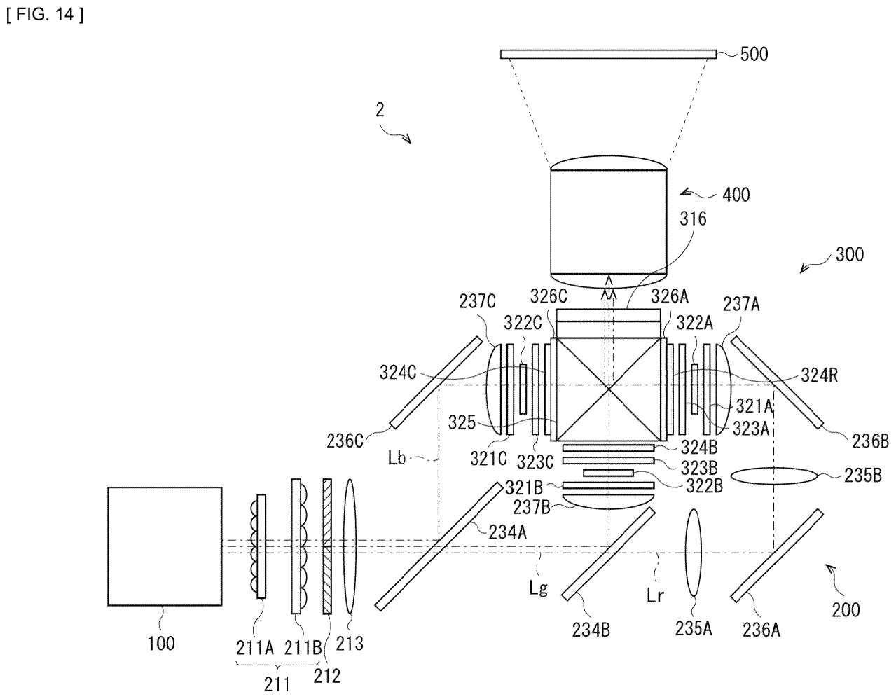

FIG. 14 illustrates another example of a schematic configuration of a projection-type display apparatus (projector 2) according to Modification Example 1 of the present disclosure. This projector 2 is a transmissive 3LCD system projector that performs light modulation by using a transmissive liquid crystal panel (LCD). The projector 2 includes the pair of fly-eye lenses 211 described in the embodiment above, and includes, similarly to the above-described projector 1, for example, the light source 100, the illumination optical system 200, the image forming unit 300, and the projection optical system 400.

The illumination optical system 200 includes, for example, the pair of fly-eye lenses 211, the polarization conversion device 212, and the condensing lens 213. The illumination optical system 200 further includes dichroic mirrors 234A and 234B, relay lenses 235A and 235B, mirrors 236A, 236B, and 236C, and field lenses 237A, 237B, and 237C.

The dichroic mirrors 234A and 234B each have a property of selectively reflecting color light in a predetermined wavelength range, and transmitting light in other wavelength ranges. For example, the dichroic mirror 234A selectively reflects the blue light Lb. The dichroic mirror 234B selectively reflects the green light Lg among the red light Lr and the green light Lg passing through the dichroic mirror 234A. The remaining red light Lr passes through the dichroic mirror 234B. This allows the white light Lw outputted from the light source 100 to be separated into a plurality of color light beams that are different from each other (red light Lr, green light Lg, and blue light Lb).

The red light Lr passes through the relay lens 235A to be reflected by the mirror 236A, and further passes through the relay lens 235B to be reflected by the mirror 236B. The red light Lr reflected by the mirror 236B passes through the field lens 237A to be collimated, and then enters a liquid crystal panel 322A for modulation of the red light Lr. The green light Lg passes through the field lens 237B to be collimated, and then enters a liquid crystal panel 322B for modulation of the green light. The separated blue light Lb is reflected by the mirror 236C, passes through the field lens 237C to be collimated, and then enters a liquid crystal panel 322C for modulation of the blue light Lb.

Incident-side polarizing plates 321A, 321B, and 321C each have a function of further aligning polarized light beams (cutting unnecessary polarized light beams) aligned by the polarization conversion device 212.

The liquid crystal panels 322A, 322B, and 322C correspond to one specific example of “light modulation device” of the present disclosure. The liquid crystal panels 322A, 322B, and 322C are each electrically coupled to a signal source (for example, a PC) (not illustrated) that supplies an image signal including image information. The liquid crystal panels 322A, 322B, and 322C each modulate incident light for each pixel to generate a corresponding one of a red image, a green image, and a blue image on the basis of the supplied image signal of each color. Out of the modulated light beams of the respective colors (formed images), the red light Lr passes through an exit-side pre-polarizing plate 323A, an exit-side main polarizing plate 324A, and a λ/2 plate 326A to enter a dichroic prism 325. The green light Lg passes through an exit-side pre-polarizing plate 323B and an exit-side main polarizing plate 324B to enter the dichroic prism 325. The blue light Lb passes through an exit-side pre-polarizing plate 323C, an exit-side main polarizing plate 324C, and a λ/2 plate 326C to enter the dichroic prism 325. The modulated light beams of the respective colors (formed images) are combined in the dichroic prism 325.

The exit-side pre-polarizing plates 323A, 323B, and 323C each cut polarized light unnecessary at the time of black display in a corresponding one of the liquid crystal panels 322A, 322B, and 322C. The exit-side main polarizing plates 324A, 324B, and 324C each further cut unnecessary polarized light that has not been sufficiently cut by a corresponding one of the exit-side pre-polarizing plates 323A, 323B, and 323C. The dichroic prism 325 includes three incident surfaces and one exit surface, and has a function of superimposing and combining the color light beams (red light Lr, green light Lg, and blue light Lb) that have entered the dichroic prism 325 from the respective incident surfaces to output the combined color light beams.

The wavelength-selective phase-difference device 316 is disposed between the dichroic prism 325 and the projection optical system 400.

In the projector 2, the polarization component of each color light beam entering the dichroic prism 325 is the S-polarized component in the case of the red light Lr and the blue light Lb, and is the P-polarized component in the case of the green light Lg. In this application example, the wavelength-selective phase-difference device 316 is configured to perform selective polarization conversion of light in a green range, for example. Out of the light beams outputted from the dichroic prism 325, a light beam in the green range is selectively converted into an S-polarized component. This allows image light having aligned polarization components to be output toward the projection optical system 400.

The projection optical system 400 includes, for example, a plurality of lenses, and expands the exit light outputted from the image forming unit 300 to project the expanded light onto the screen 500.

### 3. Modification Example 2

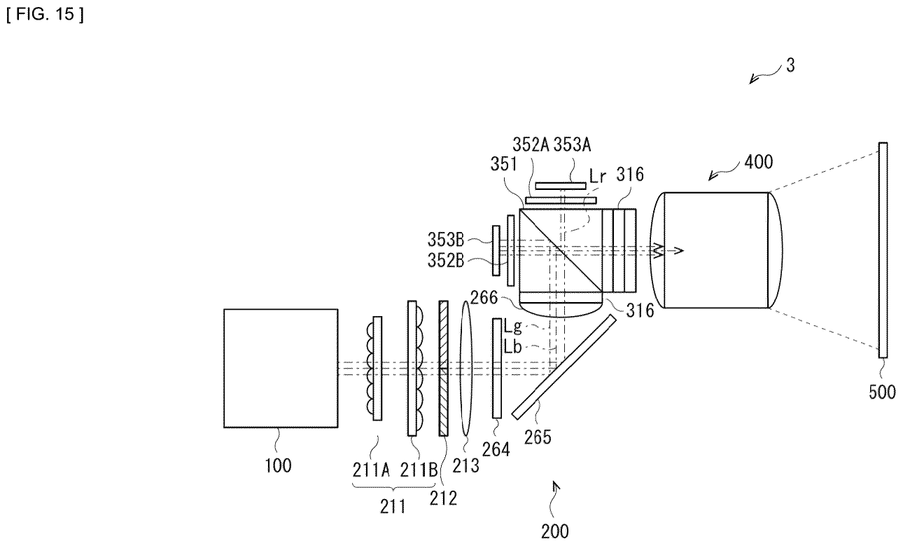

FIG. 15 illustrates another example of a schematic configuration of a projection-type display apparatus (projector 3) according to Modification Example 2 of the present disclosure. This projector 4 is a reflective 2LCD system projector that performs light modulation by using two reflective liquid crystal panels (LCDs). The projector 3 includes the pair of fly-eye lenses 211 described in the embodiment above, and includes, similarly to the above-described projector 1, for example, the light source 100, the illumination optical system 200, the image forming unit 300, and the projection optical system 400.

The illumination optical system 200 includes, for example, the pair of fly-eye lenses 211, the polarization conversion device 212, and the condensing lens 213. The illumination optical system 200 further includes a polarizing plate 264, a mirror 265, and a field lens 266.

The image forming unit 300 includes a PBS 351, ¼ wavelength plates 352A and 352B, and liquid crystal panels 353A and 353B.

The PBS 351 separates light in a predetermined wavelength range on the basis of a polarization direction. The wavelength-selective PBS 351 is configured to, for example, reflect a S-polarized component and transmit a P-polarized component. In the projector 3, S-polarized blue light Lb and S-polarized green light Lg are selectively reflected at a wavelength selection surface, and P-polarized red light Lr passes therethrough.

The liquid crystal panels 353A and 353B each optically-modify incident light to output optically-modified light, for example, each modify illumination light on the basis of a picture signal to output modified light. The liquid crystal panels 353A and 353B each convert the incident light into polarized light in a state orthogonal to the incident polarization to output the polarized light.

In the projector 3, the wavelength-selective phase-difference device 316 is disposed between the PBS 351 and the projection optical system 400 and between the field lens 266 and the PBS 351.

The wavelength-selective phase-difference device 316 disposed between the PBS 351 and the projection optical system 400 is configured to, for example, perform selective polarization conversion of light beams in the green range and the blue range, and selectively converts, out of the light beams outputted from the PBS 351, light beams in the green range and the blue range into S-polarized components. This allows image light having aligned polarization components to be output toward the projection optical system 400.

The wavelength-selective phase-difference device 316 disposed between the field lens 266 and the PBS 351 is configured to selectively rotate the polarization directions of light beams in, out of the red range, the green range, and the blue range, the green range and the blue range (is configured to transmit the light beam in the red range while maintaining its polarization direction).

The projection optical system 400 includes, for example, a plurality of lenses, and expands the exit light outputted from the image forming unit 300 to project the expanded light onto the screen 500.

The present technique has been described above with reference to the embodiment and Modification Examples 1 and 2, but the present technique is not limited to the above-described embodiment and the like, and is modifiable in a variety of ways. For example, in the above-described projectors 1 to 3, an example in which one light source 100 that emits white light Lw is used as the light source has been described, but the present disclosure is not limited thereto. For example, the above-described projectors 1 to 3 may each be configured to use a plurality of light sources (red light source, green light source, and blue light source) that each emit the red light Lr, the green light Lg, or the blue light Lb.

Further, as the projection-type display apparatus according to the present technique, apparatus other than the above-described projectors 1 to 3 may be used. For example, in the above-described projectors 1 to 3, an example in which a reflective liquid crystal panel or a transmissive liquid crystal panel is used as the light modulation device has been described, but the present technique may be applied also to a projector using a digital micro-mirror device (DMD) or the like.

It is to be noted that the effects described herein are not necessarily limited, and may include any of the effects described in the present disclosure.

It is to be noted that the present technique may take the following configurations. According to the present technique having the following configurations, because of the usage of a first fly-eye lens that divides exit light outputted from a light source into a plurality of light fluxes and expands the exit light to output expanded light, and a second fly-eye lens that is disposed downstream of the first fly-eye lens and includes a plurality of second lens cells having a one-to-one correspondence to a plurality of first lens cells included in the first fly-eye lens and having a lens pitch larger than that of the plurality of first lens cells, it is possible to decrease the F-number of the pair of fly-eye lenses. It is thus possible to improve the illumination efficiency.

(1)

An illumination optical system including:
a first fly-eye lens that divides exit light outputted from a light source into a plurality of light fluxes and expands the exit light to output expanded light, the first fly-eye lens including a plurality of first lens cells vertically and horizontally arranged in a matrix; and
a second fly-eye lens disposed downstream of the first fly-eye lens, the second fly-eye lens including a plurality of second lens cells vertically and horizontally arranged in a matrix, the plurality of second lens cells having a one-to-one correspondence to the plurality of first lens cells included in the first fly-eye lens and having a lens pitch larger than a lens pitch of the plurality of first lens cells.
   (2)

The illumination optical system according to (1), in which
an optical axis of each of the plurality of first lens cells is eccentric in a vertical direction and a horizontal direction of a lens surface of the first fly-eye lens, toward an outer side from a center portion of the first fly-eye lens, and
an optical axis of each of the plurality of second lens cells is eccentric in the vertical direction and the horizontal direction of a lens surface of the second fly-eye lens, toward an inner side from a center portion of the second fly-eye lens.
   (3)

The illumination optical system according to (2), in which
each of the plurality of first lens cells has the lens surface having a substantially rectangular shape, and
each of the plurality of first lens cells has an amount of eccentricity in the vertical direction and an amount of eccentricity in the horizontal direction which are different from each other.
   (4)

The illumination optical system according to (2) or (3), in which
each of the plurality of second lens cells has the lens surface having a substantially rectangular shape, and
each of the plurality of second lens cells has an eccentricity ratio in the vertical direction and an amount of eccentricity in the horizontal direction which are different from each other.
   (5)

The illumination optical system according to any one of (1) to (4), in which each of the first fly-eye lens and the second fly-eye lens has a lens surface having a substantially paraboloidal surface shape.

(6)

The illumination optical system according to any one of (1) to (5), in which the first fly-eye lens has a concave substantially-paraboloidal-surface shape on a light incident side.

(7)

The illumination optical system according to any one of (1) to (6), in which the second fly-eye lens has a convex substantially-paraboloidal-surface shape on a light exit side.

(8)

A projection-type display apparatus including:
a light source;
an illumination optical system;
an image generation optical system that generates image light by modulating light from the illumination optical system on a basis of an input picture signal; and
a projection optical system that projects the image light generated in the image generation optical system, in which
the illumination optical system includes:
a first fly-eye lens that divides exit light outputted from the light source into a plurality of light fluxes and expands the exit light to output expanded light, the first fly-eye lens including a plurality of first lens cells vertically and horizontally arranged in a matrix; and
a second fly-eye lens disposed downstream of the first fly-eye lens, the second fly-eye lens including a plurality of second lens cells vertically and horizontally arranged in a matrix, the plurality of second lens cells having a one-to-one correspondence to the plurality of first lens cells included in the first fly-eye lens and having a lens pitch larger than a lens pitch of the plurality of first lens cells.
   (9)

An optical member in which a plurality of lens cells that divides incident light into a plurality of light fluxes is vertically and horizontally arranged in a matrix, and a lens surface formed by the plurality of lens cells has a substantially paraboloidal surface shape.

(10)

The optical member according to (9), in which the optical member expands the incident light to output expanded light.

(11)

A projection-type display apparatus including:
a light source;
an illumination optical system including a first optical member and a second optical member provided as a pair;
an image generation optical system that generates image light by modulating light from the illumination optical system on a basis of an input picture signal; and
a projection optical system that projects the image light generated in the image generation optical system, in which
each of the first optical member and the second optical member is configured in a manner in which a plurality of lens cells that divides exit light outputted from the light source into a plurality of light fluxes is vertically and horizontally arranged in a matrix, and a lens surface formed by the plurality of lens cells has a substantially paraboloidal surface shape.

The present application claims the benefit of Japanese Priority Patent Application JP2021-197090 filed with the Japan Patent Office on Dec. 3, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An illumination optical system comprising:
a first fly-eye lens that divides exit light outputted from a light source into a plurality of light fluxes and expands the exit light to output expanded light, the first fly-eye lens including a plurality of first lens cells vertically and horizontally arranged in a matrix; and
a second fly-eye lens disposed downstream of the first fly-eye lens, the second fly-eye lens including a plurality of second lens cells vertically and horizontally arranged in a matrix, the plurality of second lens cells having a one-to-one correspondence to the plurality of first lens cells included in the first fly-eye lens and having a lens pitch larger than a lens pitch of the plurality of first lens cells.

2. The illumination optical system according to claim 1, wherein
an optical axis of each of the plurality of first lens cells is eccentric in a vertical direction and a horizontal direction of a lens surface of the first fly-eye lens, toward an outer side from a center portion of the first fly-eye lens, and
an optical axis of each of the plurality of second lens cells is eccentric in the vertical direction and the horizontal direction of a lens surface of the second fly-eye lens, toward an inner side from a center portion of the second fly-eye lens.

3. The illumination optical system according to claim 2, wherein
each of the plurality of first lens cells has the lens surface having a substantially rectangular shape, and
each of the plurality of first lens cells has an amount of eccentricity in the vertical direction and an amount of eccentricity in the horizontal direction which are different from each other.

4. The illumination optical system according to claim 2, wherein
each of the plurality of second lens cells has the lens surface having a substantially rectangular shape, and
each of the plurality of second lens cells has an eccentricity ratio in the vertical direction and an amount of eccentricity in the horizontal direction which are different from each other.

5. The illumination optical system according to claim 1, wherein each of the first fly-eye lens and the second fly-eye lens has a lens surface having a substantially paraboloidal surface shape.

6. The illumination optical system according to claim 1, wherein the first fly-eye lens has a concave substantially-paraboloidal-surface shape on a light incident side.

7. The illumination optical system according to claim 1, wherein the second fly-eye lens has a convex substantially-paraboloidal-surface shape on a light exit side.

8. A projection-type display apparatus comprising:
a light source;
an illumination optical system;
an image generation optical system that generates image light by modulating light from the illumination optical system on a basis of an input picture signal; and
a projection optical system that projects the image light generated in the image generation optical system, wherein
the illumination optical system includes:
a first fly-eye lens that divides exit light outputted from the light source into a plurality of light fluxes and expands the exit light to output expanded light, the first fly-eye lens including a plurality of first lens cells vertically and horizontally arranged in a matrix; and
a second fly-eye lens disposed downstream of the first fly-eye lens, the second fly-eye lens including a plurality of second lens cells vertically and horizontally arranged in a matrix, the plurality of second lens cells having a one-to-one correspondence to the plurality of first lens cells included in the first fly-eye lens and having a lens pitch larger than a lens pitch of the plurality of first lens cells.
